(19) United States
(12) Patent Application Publication
(10) Pub. No.: US 2003/0136795 A1
(43) Pub. Date: Jul. 24, 2003

(54) Lacquer bullet gun magazine

(76) Inventor: Chih-Chen Juan, Chiayi City (TW)

Correspondence Address: Keith Kline, PRO-TECHTOR INTERNATIONAL SERVICES, 20775 Norada Court, Saratoga, CA, 95070-3018, US

(21) Appl. No.: 10/054,798

(22) Filed: Jan. 22, 2002

(51) Int. Cl. B65H 1/00; B65D 83/00; A45D 24/22; B67D 1/00

(52) U.S. Cl. 221/198; 222/198

(57) ABSTRACT

A lacquer bullet gun magazine, comprising a storing case and a pushing device. The storing case accommodates lacquer bullets and has a central axis and an exit opening which is connected with a feeding tube of a lacquer barrel gun. The pushing device is placed inside the storing case for pushing the lacquer bullets towards the exit opening and further comprises a pushing element, gliding within the storing case along the central axis thereof, and a spring, driving the pushing element towards the exit opening. Thus the pushing element pushes the lacquer bullets towards the exit opening.

### BACKGROUND OF THE INVENTION

1. Field of the Invention

The present invention relates to a lacquer bullet gun magazine, particularly to a lacquer bullet gun magazine ensuring smooth feeding of bullets and reducing blocking of bullets.

2. Description of Related Art

In popular war games, war scenes of dueling parties are simulated, providing for interesting and exciting entertainment, which is appealing especially to young people. For these war games, lacquer bullet guns are used which are powered by compressed gas. Lacquer bullets that are loaded into a lacquer gun are taken along by expansion of compressed gas and pushed out through a barrel. Lacquer bullets to be fired are placed in a storing case. For continuous firing, stored lacquer bullets fall successively into a feeding tube to be fired from within the lacquer bullet gun.

A conventional lacquer bullet storing and feeding system comprises: a storing case, having a curved inner side; an exit opening at a lowermost location of the storing case, connected with a feeding tube that leads to the lacquer barrel gun.

The lacquer bullets have round shapes, thus rolling along the curved inner side of the storing case, reaching the exit opening. Usually a user continually sways the lacquer bullet gun, stirring the lacquer bullets, so that the lacquer bullets by their own weight fall down from the exit opening. However, the lacquer bullets, being made of lacquer coated by glue, are light and readily stick together when falling down the feeding tube. Also, several lacquer bullets may clump together at an edge of the exit opening, so that the feeding tube is blocked and firing of lacquer bullets is interrupted, not permitting continuous firing. Then the user has to shake the lacquer bullet gun forcefully to free the lacquer bullets, allowing them to fall down the feeding tube one by one, which is inconvenient for timing of a wargame.

### SUMMARY OF THE INVENTION

The present invention is an improved lacquer bullet magazine, providing an improved process smooth feeding of lacquer bullets into a lacquer bullet gun.

It is the main object of the present invention to provide a lacquer bullet gun magazine which forcefully pushes lacquer bullets towards an exit opening, preventing lacquer bullets from being stuck on the way from a storing case to the lacquer bullet gun, so that firing thereof is not blocked.

Therein, a pushing device is installed in the storing case, having a pushing element and a spring which drives the pushing element to push lacquer bullets towards an exit opening, forcing lacquer bullets to enter the lacquer bullet gun. Thus lacquer bullets will not be stuck inside the storing case.

The present invention can be more fully understood by reference to the following description and accompanying drawings.

### BRIEF DESCRIPTION OF THE DRAWINGS

FIG. 1 is a side view of the lacquer bullet gun magazine of the present invention in the first embodiment, mounted on a lacquer bullet gun.

FIG. 2 is a side view of the present invention in the first embodiment, filled with lacquer bullets.

FIG. 3 is a side view of the present invention in the first embodiment, with lacquer bullets almost used up.

FIG. 4 is a side view of the lacquer bullet gun magazine of the present invention in the second embodiment, mounted on a lacquer bullet gun.

FIG. 5 is a side view of the present invention in the second embodiment, filled with lacquer bullets.

FIG. 6 is a side view of the present invention in the second embodiment, with lacquer bullets almost used up.

### DETAILED DESCRIPTION OF THE PREFERRED EMBODIMENTS

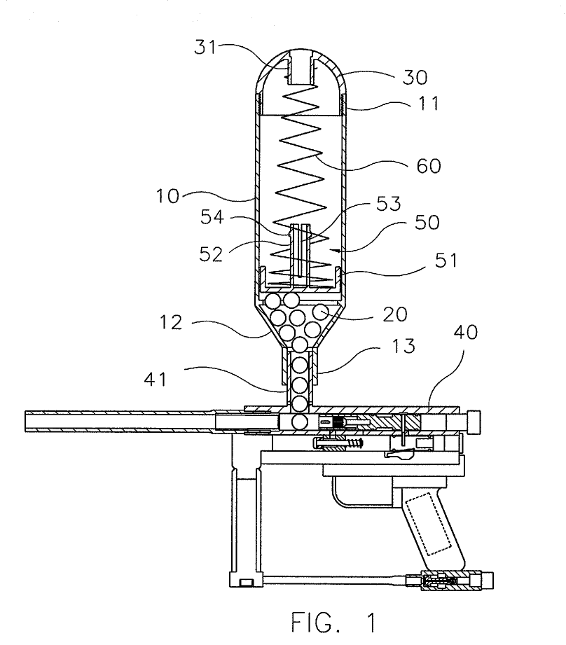

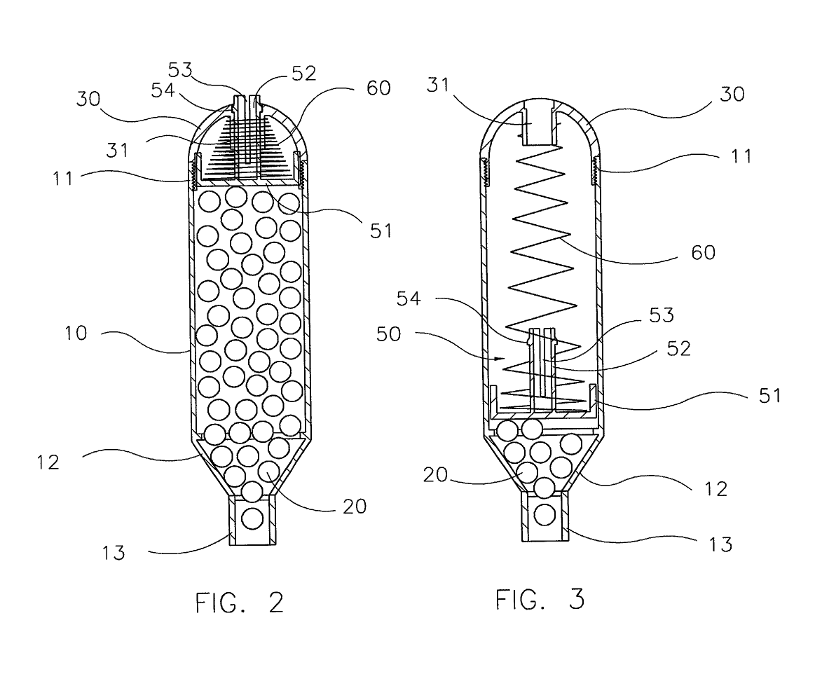

As shown in FIGS. 1 and 2, the lacquer bullet gun magazine of the present invention in a first embodiment mainly comprises: a storing case 10; a funnel 12; and a pushing device 50. The storing case 10 is cylindrically shaped having an upper end with an upper opening 11 for filling in lacquer bullets 20. The funnel 12 has an exit opening 13 at a lowermost location, which is connected with a feeding tube 41 of a lacquer barrel gun 40. The funnel 12 has an upper end that is connected with the storing case 10 and has a relatively large diameter and a lower end with a relatively small diameter. Thus lacquer bullets 20 are led to the exit opening 13.

A top part 30 is set on the upper end of the storing case 10. The top part 30 can be removed to allow to fill lacquer bullets 20 into the storing case 10. The pushing device 50 is mounted inside the storing case 10, pushing lacquer bullets 20 towards the exit opening 13. The pushing device 50 comprises a pushing element 51 and a spring 60. The pushing element 51 is a circular plate having a diameter that is slightly smaller than the inner diameter of the storing case 10. The spring 60 leans on the pushing element 51 from above, driving the pushing element 51 downward, towards the exit opening 13.

The top part 30 has an inner side to which a tube 31 is attached in a coaxial position. Facing the top part 30, a blocking rod 52 is set on the pushing element 51 in a coaxial position. The spring 60 at both ends thereof surrounds the tube 31 and the blocking rod 52, respectively. In the first embodiment of the present invention, the spring 60 has an outer shape like a cone for better elastic properties. As shown in FIG. 2, when the pushing element 51 is located at a topmost position within the storing case 10, the spring 60 is compressed to an extreme degree. On the other hand, as shown in FIG. 3, when the spring 60 expands, the pushing element 51 is driven downward, towards the exit opening 13, pushing lacquer bullets 20 towards the exit opening 13, forcing lacquer bullets 20 to enter the feeding tube 41 of the lacquer bullet gun 40.

At least two slits 53 are cut into the blocking rod 52. Furthermore, the blocking rod 52 has a far end and a peripheral outer side, to which, close to the far end, several blocking elements 54 are attached. As shown in FIG. 2, the blocking rod 52 is longer than the tube 31. When the blocking rod 52 has entered the tube 31, the blocking elements 54 protrude from an upper end of the tube 31, holding the pushing element 51 close to the top part 30. As further shown in FIG. 2, thus holding the pushing element 51 close to the upper opening 11 of the storing case 10 enables a user easily to fill lacquer bullets 20 into the storing case 10. As soon as the user with a fingertips presses down on the blocking rod 52, the blocking elements 54 are separated from the tube 31, and the pushing element 51 undergoes pressure by the spring 60, which pushes lacquer bullets 20 down towards the exit opening 13, forcing lacquer bullets 20 to enter the lacquer bullet gun.

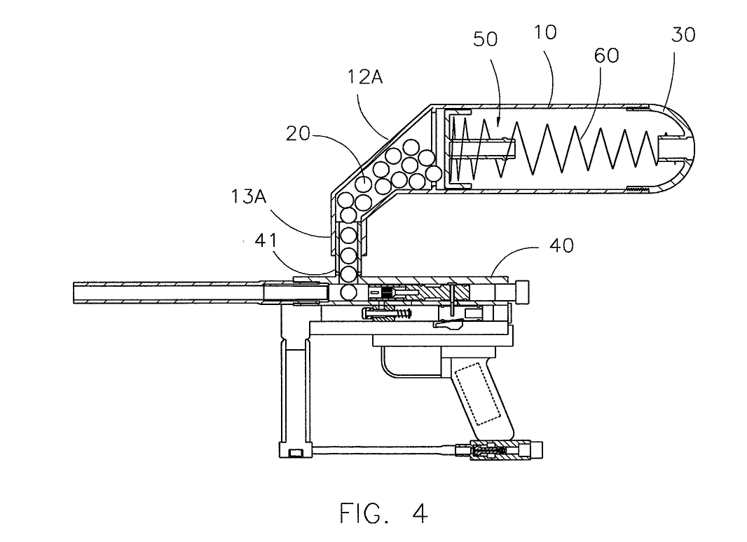

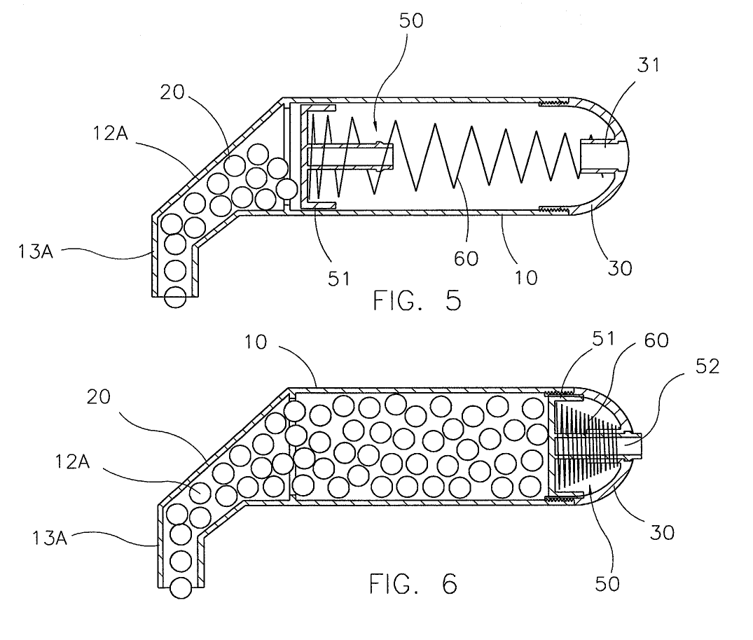

In the first embodiment of the present invention, the storing case 10, the funnel 12 and the exit opening 13 share a common central axis. Referring to FIGS. 4, 5 and 6, in a second embodiment of the present invention, the storing case 10, the top part 30, the pushing 5 device 50 and the spring 60 are the same as in the first embodiment. However, a bent funnel 12A is used, having a lower end with an exit opening 13A. The exit opening 13A surrounds a second axis that is oriented at an angle with the central axis of the storing case 10. Thus, as shown in FIG. 4, the storing case 10, when mounted on the lacquer bullet gun 40, is roughly oriented parallel thereto.

The main advantage of the present invention, as compared to conventional storing and feeding systems, lies in, by the pushing device 50 forcing lacquer bullets 20 through the exit opening 13 of the storing case 10, preventing lacquer bullets 20 from being stuck within the storing case 10 and not being able to be fired. Therefore, lacquer bullets are fired smoothly without blocking thereof.

While the invention has been described with reference to preferred embodiments thereof, it is to be understood that modifications or variations may be easily made without departing from the spirit of this invention which is defined by the appended claims.

1. A lacquer bullet gun magazine, comprising:
a storing case, accommodating lacquer bullets, having a central axis and a first end with an exit opening which is connected with a feeding tube of a lacquer barrel gun, so that said lacquer bullets are led into said feeding tube of said lacquer barrel gun; and
a pushing device inside said storing case, pushing said lacquer bullets towards said exit opening, further comprising
a pushing element, gliding within said storing case along said central axis thereof, and
a spring, driving said pushing element towards said exit opening;
wherein said pushing element pushes said lacquer bullets towards said exit opening.

2. A lacquer bullet gun magazine according to claim 1, wherein said pushing element has a blocking rod which is able to engage with a tube on a second end of said storing case for holding said pushing element at said second end of said storing case.

3. A lacquer bullet gun magazine according to claim 1, wherein said exit opening is placed around a symmetry axis that is identical with said central axis of said storing case.

4. A lacquer bullet gun magazine according to claim 1, wherein said exit opening is placed around a symmetry axis that is oriented at an angle with respect to said central axis of said storing case.
